(19) United States
(12) Patent Application Publication
(10) Pub. No.: US 2015/0318738 A1
(43) Pub. Date: Nov. 5, 2015

(54) Adaptive Power Management System for Electronic Apparatus

(71) Applicant: Yang Pan, Singapore (SG)

(72) Inventor: Yang Pan, Singapore (SG)

(21) Appl. No.: 14/269,146

(22) Filed: May 4, 2014

(51) Int. Cl. H02J 13/00; H02J 4/00

(52) U.S. Cl. CPC H02J 13/00; H02J 4/00

(57) ABSTRACT

Adaptive power management system comprises an electronic apparatus and a power supply connected through a power limiter to the apparatus. A controller is employed for setting up maximum allowed power flowing from the power supply to the apparatus. The apparatus selects a subset of its functionalities based upon the maximum power. The apparatus learns a satisfactory level of functionalities for a user through an iterative process under the maximum power constraint. A benchmark engine in a network can provide data to speed up the learning.

### CROSS-REFERENCE TO RELATED APPLICATIONS

Not applicable.

### BACKGROUND

1. Field of Invention

This invention relates to an electronic apparatus, specifically to an energy efficient electronic apparatus.

2. Description of Prior Art

For various reasons, energy consumption is being increasingly scrutinized by residential and business consumers. Much effort has been made in recent years to provide electronic apparatus of all types that consume reduced amount of electrical power. Such apparatus have been well received in the market place and are highly desirable. While great strides have been made in providing energy efficient apparatus, more improvements are desired in particularly in areas of consuming of electrical power more efficiently.

There are basically two types of electronic apparatus: one consumes electrical power available from a utility and another consumes power of an energy storage device such as a battery. The first type includes but is not limited to an air conditioner, a refrigerator, a microwave oven, a television and a HiFi audio system. The second type includes but is not limited to a mobile phone, a tablet computer, a wearable electronic device and a laptop computer. Modern electronic apparatus almost always provides many more functionalities than what a typical user requires. It is not unusual that a user employs only a subset of total available functionalities of an apparatus.

It is always desirable to reduce power consumption as much as possible while still delivering satisfactory functionalities to a user.

### SUMMARY OF THE INVENTION

It is an object of the present invention to providing an energy efficient electronic apparatus.

It is another object of the present invention to providing a means of reducing power consumption of the electronic apparatus by placing a programmable power limiter between the apparatus and a power supply.

It is yet another object of the present invention to providing a means of reducing power consumption of the electronic apparatus by forcing a processor of the apparatus to learn to select a subset of functionalities under a maximum power constraint and to satisfy requirement of a user.

It is still another object of the present invention to providing a means of reducing power consumption of the electronic apparatus by benchmarking power consumptions of a plurality of similar apparatus connected to a benchmark engine in a communication network.

### BRIEF DESCRIPTION OF THE DRAWINGS

For a more complete understanding of the present invention and its various embodiments, and the advantages thereof, reference is now made to the following description taken in conjunction with the accompanying drawings:

FIG. 1 is a schematic diagram of an exemplary energy efficient electronic apparatus;

FIG. 2 is a schematic diagram illustrating exemplarily selectable subsets of functionalities versus power consumptions;

FIG. 3 is a schematic diagram illustrating an exemplary implementation of an AC power limiter;

FIG. 4 is a schematic diagram illustrating an exemplary implementation of a DC power limiter with AC power source;

FIG. 5 is a schematic diagram illustrating an exemplary implementation of a DC power limiter with DC power source;

FIG. 6 is a flow diagram depicting power saving operation of the apparatus;

FIG. 7 is a flow diagram depicting power saving operation of the apparatus connected to a benchmark engine in a communication network.

### DETAILED DESCRIPTION

The present invention will now be described in detail with references to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps have not been described in detail in order not to unnecessarily obscure the present invention.

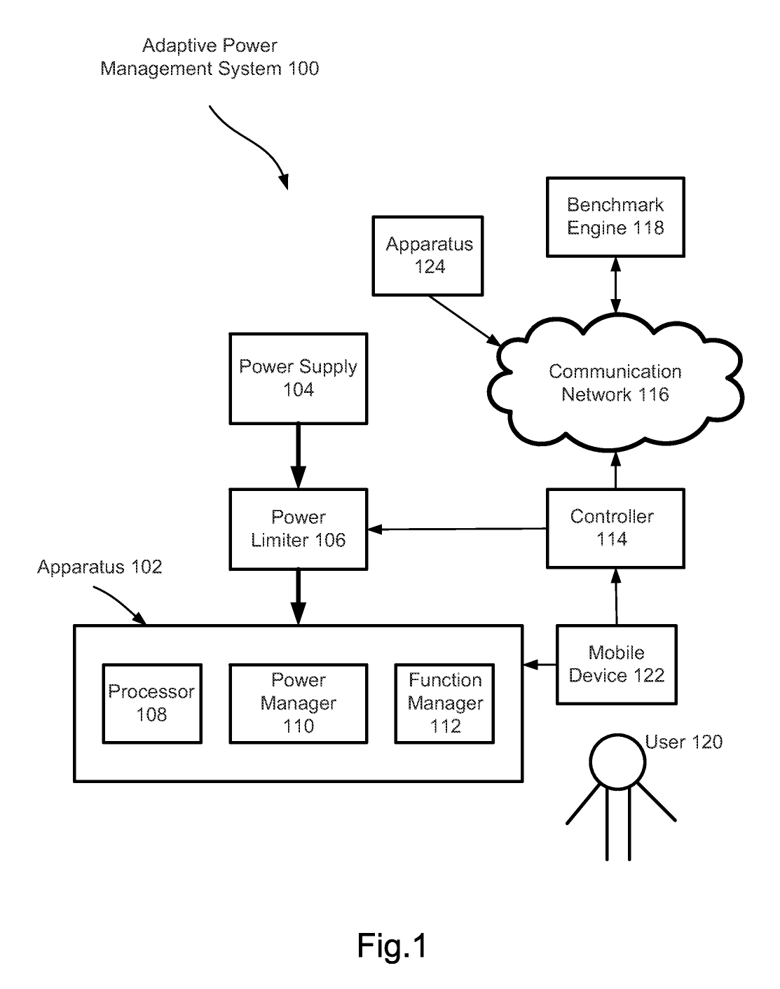

FIG. 1 is a schematic diagram of an exemplary adaptive power management system 100. An electronic apparatus 102 is connected to a power supply 104 through a power limiter 106. Apparatus 102 includes electrical appliances such as, for example, a refrigerator, an air conditioner, an air fresher and a microwave oven. The electrical appliance draws electrical power directly from an AC power source including but not limited to a power grid. Apparatus 102 further includes electronic devices such as, for example, a desktop computer that consumes DC power converted from an AC source through an AC/DC converter. Apparatus 102 still includes mobile electronic devices such as, for example, a mobile phone, a tablet computer, a laptop computer and a wearable electronic device powered by such a power storage device as a battery. Apparatus 102 includes a processor 108, a power manager 110 and a function manager 112. Processor 108 may be a microprocessor or a microcontroller pertaining to controlling operation of the apparatus. Processor 108 may also include other data processing capabilities such as a digital signal processor or an analog signal processor. Power manager 110 manages power consumption of the apparatus 102. Power manager 110 may be a software program stored in a storage unit and be executable by processor 108. Power manager 110 may also include hardware or firmware. Function manager 112 manages selecting a subset of the functionalities from all functionalities of the apparatus 102 when the maximum allowed power consumption of the apparatus is limited by the power limiter 106. Function manager 112 may be a software program stored in a storage unit and be executable by processor 108. Function manager 112 may also include hardware and firmware.

Power limiter 106 is a programmable device in one implementation. Controller 114 controls operation of power limiter 106 by setting up and modifying the maximum power allowed to flow from power supply 104 to apparatus 102. In one implementation, controller 114 is connected to power limiter 106 through a wired connection. In another implementation, controller 114 is connected to power limiter through a wireless connection.

Power limiter 106 can be implemented in an electrical domain. Power limiter 106 can also be implemented in an electrical-thermal domain. In one implementation power limiter is an AC power limiter. In another implementation, power limiter 106 is a DC power limiter. The DC power limiter may be connected to an AC/DC power converter.

Controller 114 is connectable to a communication network 116. In one implementation, controller 114 is connected to the communication network directly through a wireless or wired connection. In another implementation, controller 114 is connected to the communication network through another device. In one implementation, a benchmark engine 118 is connected to the communication network 116. Benchmark engine 118 may be a function provided by a server or a virtual server in the network 116 that collects and stores power consumption data from a plurality of electronic apparatus, illustrated exemplarily as apparatus 124. Controller 114 may receive the power consumption performance data of a plurality similar apparatus as apparatus 102. Controller 114 may generate the maximum allowed power based at least partly on the power consumption performance data.

A user 120 can interact with system 100 through a mobile communication device 122 including but not limited to a mobile phone, a tablet computer, a laptop computer and a wearable electronic device. Mobile device 122 can interact with apparatus 102 or controller 114. In one implementation, mobile device 122 can instruct controller 114 to increase or decrease the maximum allowed power. In another implementation, mobile device 122 can interact directly with apparatus 102 by increasing or decreasing its functionalities through function manager 112. The maximum allowed power can be adjusted accordingly with the changing of delivered functionalities.

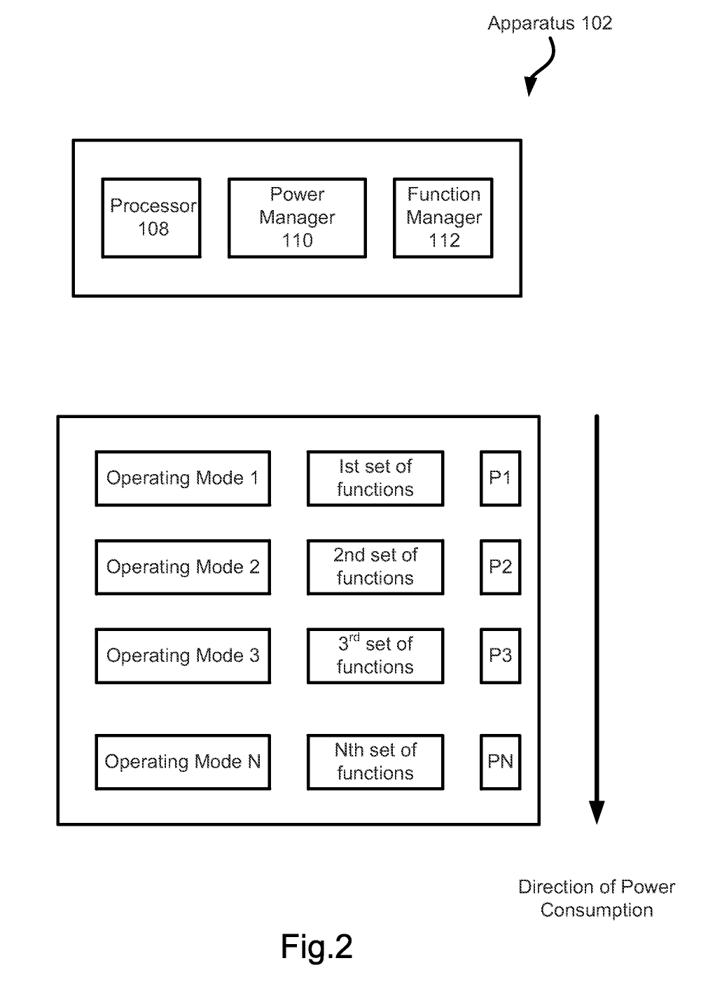

FIG. 2 is a schematic diagram illustrating exemplarily selected functionalities versus power consumptions. According to one implementation, the processor 108 includes multiple operating modes and is called multi-mode processor. The apparatus 102 provides a plurality of functionalities. Each of the operating modes can support a subset of functionalities. Each of operating modes consumes substantially different power (P1 to PN). The direction of power consumption is illustrated in the bottom part of FIG. 2.

Power manager 110 either receives maximum power from power limiter 106 or controller 114 or measures the maximum allowed power in a dynamic manner. After the maximum power is determined, function manager 112 selects an operation mode in accordance with the maximum power. Processor 108 may include a comprehensive matrix that associates the subsets of the functionalities with power consumptions. In one implementation, processor 108 through function manager 112 selects the operating mode through a predetermined matrix as shown in FIG. 2. In another implementation, processor 108 through function manager 112 selects a subset of the functionalities in accordance with the maximum power in an ad hoc manner. The selection may be based upon a user's interactions through mobile device 122 for a predetermined period of time. The predetermined period time includes a month or a week in an exemplary manner. The selection may also be based upon data available from benchmark engine 118.

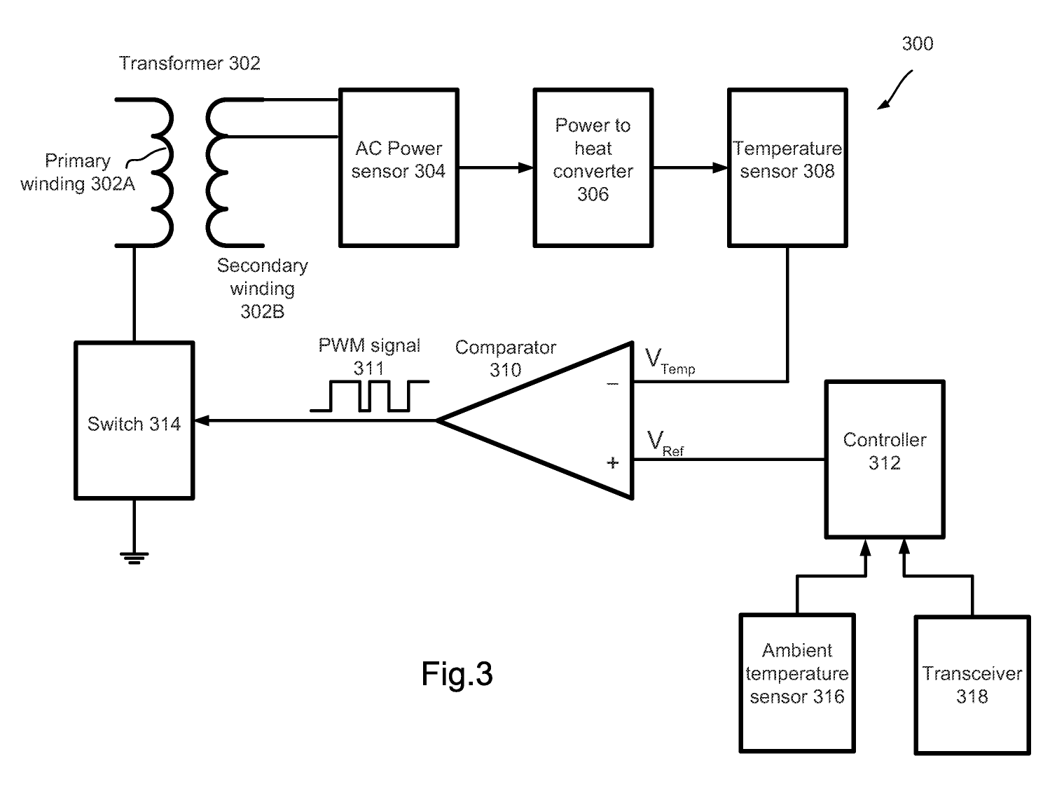

Power limiter 106 may be implemented in an electrical domain. Power limiter 106 may also be implemented in an electrical-thermal domain. FIG. 3 is an exemplary power limiter implemented in AC power domain based upon an integrated circuit for measurements of thermal signals comprising a thermal feedback loop.

Such an implementation is known from an article by Pan (the present inventor) and Huijsing in Electronic Letters 24 (1988), 542-543. This circuit is theoretically appropriate for measuring physical quantities such as speed of flow, pressure, IR-radiation, or effective value of electrical voltage or current (RMS), the influence of the quantity grated integrated circuit (chip) to its environment being determined in these cases. In these measurements, a signal conversion takes place twice: from physical (speed of flow, pressure, IR-radiation or RMS value) to the thermal domain, and from the thermal to the electrical domain.

This known semiconductor circuit theoretically consists of a heating element, integrated in the circuit, and a temperature sensor. The power dissipated in the heating element is measured with the help of an integrated amplifier unit, an amplifier with a positive feedback loop being used, because of which the temperature oscillates around a constant value with small amplitude. In the known circuit the temperature will oscillate in a natural way because of the existence of a finite transfer time of the heating element and the temperature sensor with a high amplifier-factor.

FIG. 3 shows a novel implementation of the thermal feedback principle as mentioned above to AC power limiter 300. AC power limiter 300 comprises a transformer 302 including primary winding 302A and secondary winding 302B. Transformer 302 converts AC power with high amplitude in primary winding 302A to AC power with low amplitude in secondary winding 302B while maintaining the power almost constant. AC power sensor 304 coupled to secondary winding 302B receives a portion of AC power proportionally. Received AC power is coupled to power to heat converter 306 that may further include a heating element. The heating element may be a heating resistor in an exemplary case. The heating element may also be an active component. Power to heat converter 306 (heating element) may be a part of an integrated circuit or a chip. According to a different implementation, a rectifier (not shown in FIG. 3) may be used to convert the AC power into DC power before it is used to heat the heating element.

Temperature sensor 308 in the same integrated circuit is used to measure the temperature of the integrated circuit (chip). According to one implementation of the present invention the heating element and temperature sensor may be placed in a microstructure such as a membrane or a cantilever beam, manufactured by a micromachining technology.

Output of temperature sensor 308 is coupled to one input of a comparator 310. Reference generated by controller 312 is coupled to another input of comparator 310. Output of comparator 310, which is a Pulse-Width Modulation (PWM) signal, is coupled to switch 314 that is further connected to primary winding 302A of transformer 302 to form a positive feedback loop. Switch 314 may be implemented in various forms as known in the art. Switch 314 may be a power Metal Oxide Semiconductor Field Effect Transistor (MOSFET) according to one implementation. Switch 314 may be a bipolar transistor according to another implementation. Switch 314 may even be a Light Emitting Diode (LED) and a photo detector. The output of comparator 310 may be used to drive the LED to emit light that will be detected by the photo detector. As soon as the measured temperature by temperature sensor 308 exceeds a predetermined value, set by the reference, the output of the comparator switches off switch 314. As a result, power sensor 304 receives no power from secondary winding 302B and the output of temperature sensor 308 starts to drop. As soon as the output is below the reference, the output of comparator 310 switches on switch 314 and therefore primary winding 302A. The temperature of the chip or the microstructure will oscillate around a small value. The output power of secondary winding 302B will remain as a constant in a sine wave form modulated by the PWM signals. The output power of transformer 302 is limited by the duty cycle of the PWM signal. The output power of transformer 302 is delivered to the apparatus 102.

The maximum output power of transformer 302 is determined by the reference that sets a level of temperature that the chip or the microstructure will oscillate around. To sustain a higher temperature, the power sensor 304 will need to draw more power from the secondary winding 302B. The reference is determined by controller 312 that is controller 114 as shown in FIG. 1. Controller 312 may further include a transceiver 318. Transceiver 318 connects controller 312 to the communication network 116 or to the mobile device 122. In an unlimited power operation mode, controller 312 may set the reference to a sufficiently high level to maintain switch 314 in an “on” state.

It should be noted that the temperature level of the microstructure or the chip also depends on ambient temperature. At a lower ambient temperature, it requires more power to heat the heating element to maintain the temperature to oscillate around the predetermined level. At a higher ambient temperature, less power is required. In one aspect of the present invention, an ambient temperature sensor 316 is used to measure the ambient temperature. The measurement results are sent to controller 312. Controller 312 determines the reference based not only upon the data from the benchmark engine 118 or an instruction from the mobile device 122 but also on the ambient temperature measured by temperature sensor 316. Temperature sensor 316 may be a sensor independent of the integrated circuit or the chip. Temperature sensor 316 may also be a part of the integrated circuit or the chip that will require an appropriate thermal isolation between temperature sensor 306 and temperature sensor 316. Such thermal isolation techniques are known in the art.

There may be different implementations of integration level of system 300. At a minimum level, 306 and 308 are integrated in a single chip or in a single microstructure. At a higher level, 310 may also be integrated (e.g. 306, 308 and 310 in a single chip). At even higher levels, 312 and 314 may also be integrated (e.g. 306, 308, 310, 312 and 314 in a single chip). At still higher level, 316 and 318 may also be integrated (e.g. 306, 308, 310, 312, 314, 316 and 318 in a single chip). All such variations shall fall within scope of inventive concepts of the present invention.

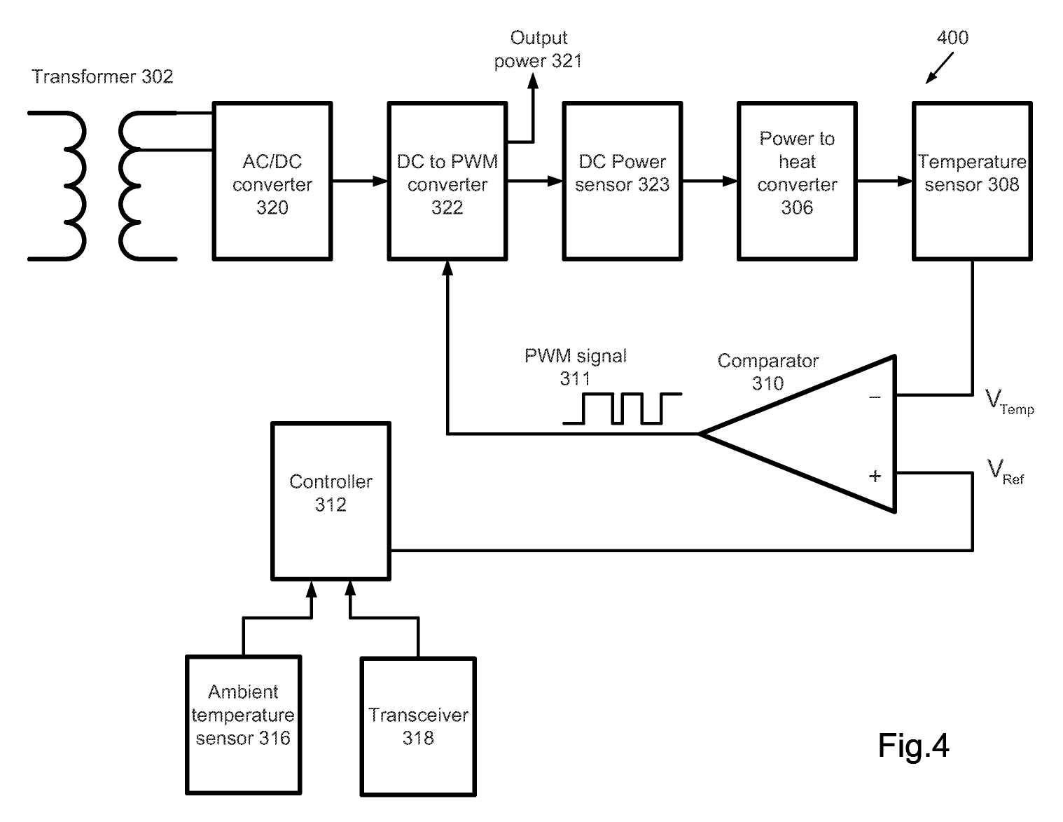

FIG. 4 shows an exemplary power limiter implemented in DC power domain with an AC power source. System 400 comprises AC/DC converter 320 that converts output power of transformer 302 from AC form into DC form. Block 322 modulates the DC power by PWM signal 311. DC power sensor 323 is coupled to Block 322 to draw a portion of DC power proportionally. Block 322 delivers output power 321 in PWM form. The DC power received by DC power sensor 323 is coupled to power to heat converter (heating element) 306. Temperature sensor 308 measures temperature of the microstructure (chip) that includes the heating element. Comparator 310 takes one input from the output of temperature sensor 308 and takes another input from a reference generated from controller 312. Output of comparator 310 in PWM form (311) is coupled to block 322 to modulate the DC power. The temperature of the chip will oscillate around a small value set by the reference. Block 322 converts output of AC/DC converter 320 into DC power in PWM form. The output power of block 322 is therefore determined by duty cycle of the PWM signal while the amplitude is kept constant. The output power of block 322 may be further processed into DC and/or AC powers before it is delivered to apparatus 102.

Similar to FIG. 3, controller 312 is coupled to ambient temperature sensor 316 and transceiver 318. Functionalities of 316 and 318 are similar to ones that have been described previously in the AC power limiter session.

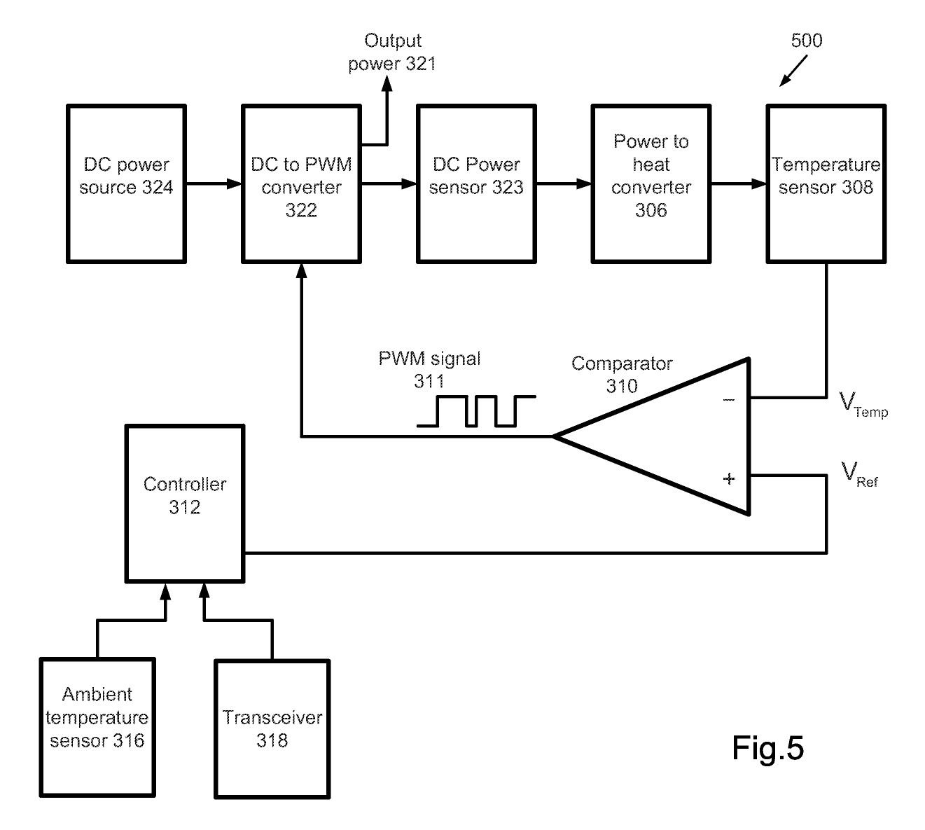

FIG. 5 shows an exemplary power limiter implemented in DC power domain with DC power source 324. Power limiter 500 is the same as power limiter 400 except that transformer 302 and AC/DC converter 320 are replaced by the DC power source 324.

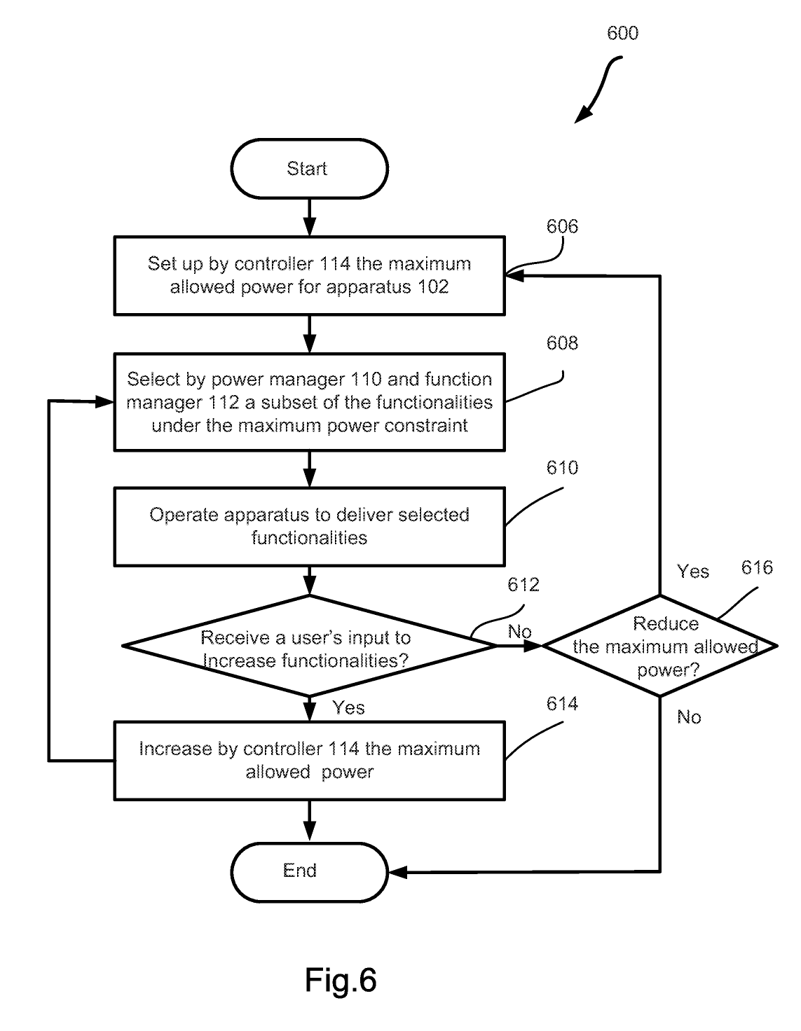

FIG. 6 is a flow diagram depicting power saving operation of the apparatus 102. Process 600 starts with step 606 that the maximum allowed power consumption for the apparatus 102 is set up by controller 114. Power manager 110 notifies the maximum power and selects a subset of the functionalities through function manager 112 under the maximum power constraint in step 608. Apparatus 102 delivers selected functionalities in step 610. A user's input to increase functionalities is checked in step 612. The user may request to increase a functionality not belonging to the subset repeatedly in exceeding of a predetermined frequency, i.e. more than once a day. The user may also request to increase performance level of the delivered functionalities of the subset. For example, the user may request that some of the functionalities to be delivered at higher speed. If such a request is confirmed, controller 114 increases the maximum power accordingly in step 614. If the result is negative, controller 114 determines in step 616 if the maximum power can be reduced while a reduced set of functionalities with at least one less functionality can still satisfy the user's requirements. In another implementation, controller 114 may also try to reduce performance level of delivering the same subset of functionalities. By attempting to reduce maximum allowed power to test a user's satisfaction level, system 100 can be forced to learn to consume less power while satisfying the requirements of a specific user. Not all users utilize all available functionalities of an apparatus. In a world, an apparatus typically over-delivers its functionalities. The present invention as depicted in process 600 will help to identify the functionalities required by the user and to reduce the power consumption accordingly.

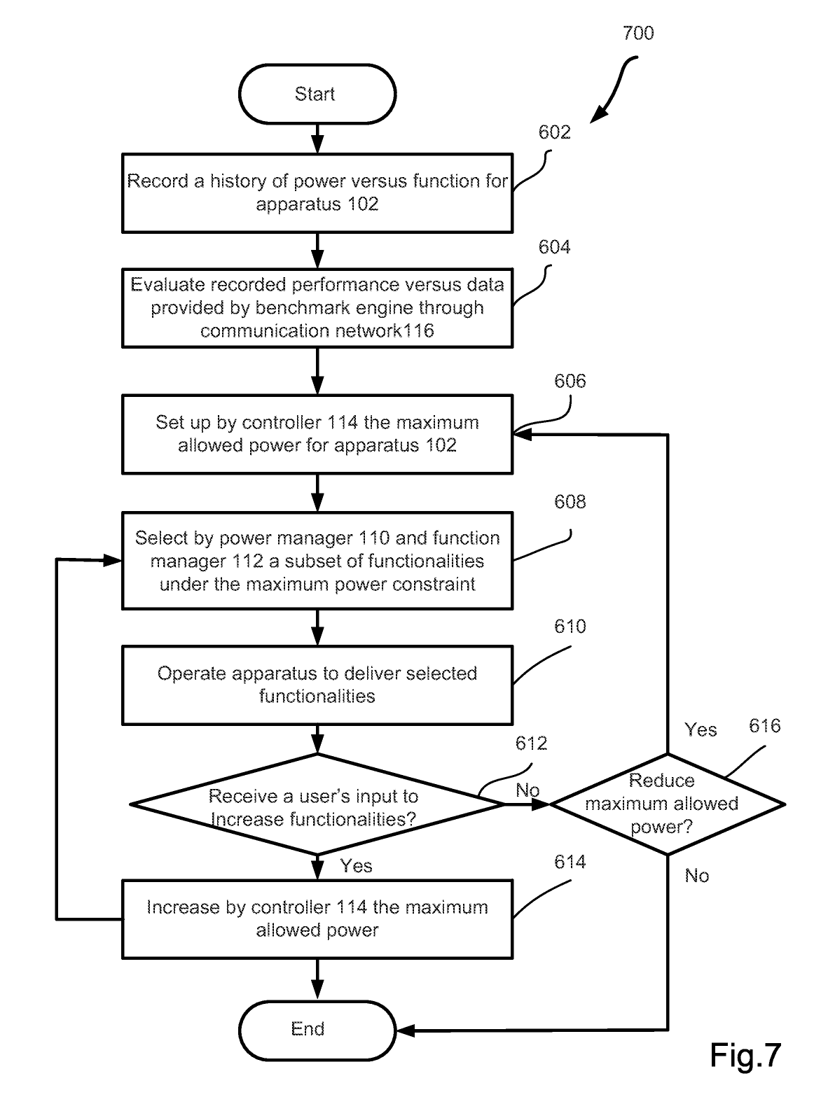

FIG. 7 depicts a process 700 similar to process 600 except that two additional steps 602 and 604 are added. In step 602, power versus functionalities history is recorded for the apparatus 102 by the processor 108. In step 604, the record is evaluated against data available from the benchmark engine 118 through the communication network 116. The maximum power is set up by controller 114 accordingly based at least partly upon the data provided from the benchmark engine 118.

1. An electronic apparatus system comprising:
(a) an electronic apparatus pertaining to delivering a plurality of functionalities;
(b) a power supply;
(c) a programmable power limiter pertaining to limiting maximum allowed power flowing from the power supply to the electronic apparatus; and
(d) a controller pertaining to controlling said power limiter,
wherein said electronic apparatus delivering a subset of the plurality of functionalities under a constraint of the maximum power imposed by said power limiter.

2. The system as recited in claim 1, wherein said controller is connected to a benchmark engine through a communication network.

3. The system as recited in claim 2, wherein said benchmark engine further including data about power consumption performances associated with at least a plurality of similar electronic apparatus belonging to a plurality of users.

4. The system as recited in claim 3, wherein said maximum power is determined by said controller based upon said data provided by said benchmark engine.

5. The system as recited in claim 2, wherein said communication network further including the Internet.

6. The system as recited in claim 1, wherein said power limiter further comprising an AC power limiter.

7. The system as recited in claim 1, wherein said power limiter further comprising a DC power limiter.

8. The system as recited in claim 1, wherein said power limiter further comprising a thermal feedback loop.

9. A method of optimizing of power consumption of an electronic apparatus comprising:
(a) connecting the apparatus to a power supply through a programmable power limiter;
(b) setting up by a controller maximum allowed power flowing from the power supply to the apparatus;
(c) selecting a subset of the functionalities from a plurality of functionalities of the apparatus, wherein said subset of the functionalities can be delivered to a user under a constraint of the maximum power;
(d) delivering the subset of the functionalities by the apparatus and monitoring the user's interactions with the apparatus; and
(e) adjusting the maximum power based upon a result of monitoring of the user's interactions.

10. The method as recited in claim 9, wherein said method further comprising connecting said controller to a benchmark engine in the Internet.

11. The method as recited in claim 10, wherein said benchmark engine provides power consumption performance data of at least a plurality of similar apparatus, wherein said data is employed by the controller for setting up the maximum power.

12. The method as recited in claim 9, wherein said user's interactions further including requesting functionalities not included in said subset of the functionalities.

13. The method as recited in claim 9, wherein said user's interactions further including requesting increasing performance level of said subset of functionalities.

14. The method as recited in claim 9, wherein said method further including adding a functionality to said subset of functionality and adjusting the maximum power accordingly if the functionality is requested by the user in exceeding of a predetermined frequency.

15. The method as recited in claim 9, wherein said method further including reducing at least one functionality from said subset and adjusting the maximum power accordingly if no user's request for increasing a functionality is received after a predetermined period of time.

16. A method of optimizing of power consumption of an electronic apparatus comprising:
(a) connecting the apparatus to a power supply through a programmable power limiter;
(b) connecting the power limiter to a controller, said controller is connected to a benchmark engine through a communication network, said benchmark engine stores at least power consumption performance data of a plurality of similar electronic apparatus;
(c) setting up maximum allowed power flowing from the power supply to the apparatus by the controller based upon at least partly on the data available from the benchmark engine;
(d) selecting a subset of the functionalities of the apparatus, wherein said subset of the functionalities can be delivered to a user under a constraint of the maximum power;
(e) delivering the subset of the functionalities by the apparatus and monitoring the user's interactions with the apparatus; and
(f) adjusting the maximum power based upon a result of monitoring of the user's interactions.

17. The method as recited in claim 16, wherein said user's interactions further including requesting functionalities not included in said subset of the functionalities.

18. The method as recited in claim 16, wherein said user's interaction further including requesting increasing performance level of said subset of the functionalities.

19. The method as recited in claim 16, wherein said method further including adding a functionality to said subset of the functionalities and adjusting maximum power accordingly if the functionality is requested by the user in exceeding of a predetermined frequency.

20. The method as recited in claim 16, wherein said method further including reducing at least one functionality from said subset and adjusting the maximum power accordingly if no user's requesting for increasing a functionality is received after a predetermined period of time.
